(19) United States
(12) Patent Application Publication
(10) Pub. No.: US 2008/0220382 A1
(43) Pub. Date: Sep. 11, 2008

(54) Lithographic apparatus and method

(75) Inventor: Petar Veselinovic, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/714,273

(22) Filed: Mar. 6, 2007

(51) Int. Cl. G03G 15/04; G03C 5/00

(52) U.S. Cl. 430/346; 399/51

(57) ABSTRACT

A lithographic apparatus includes a shutter system constructed and arranged to mask out parts of a patterning device or a substrate from a beam of radiation. The shutter system includes at least one moveable shutter. The apparatus also includes a control unit arranged to receive information regarding the extent to which a patterned beam of radiation would extend across a periphery of the substrate when being projected onto the target region of the substrate. The control unit is configured to move the shutter by a predetermined amount to affect the parts of the patterning device or the substrate masked out from the beam of radiation if projecting the patterned beam of radiation onto the target portion would involve the patterned beam of radiation extending across the periphery of the substrate.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

When irradiating a target portion which is located in or around the center of a substrate, the radiation beam is only incident on those target portions. However, when irradiating target portions which are on the periphery of the substrate, a part of the radiation beam used to expose the target portion will not be incident on the substrate. The radiation which is not incident on the substrate may be incident on, for example, a substrate table which holds the substrate in position. Radiation not incident on the substrate is effectively wasted. The wasted radiation will also unnecessarily heat up the patterning device, lenses and anything else which it comes into contact with. Irradiation of the substrate table may cause it to heat up and expand. Expansion of the substrate table (or any other part of the lithographic apparatus) is, in general, undesirable since it makes it more difficult to accurately apply a pattern to the target portion of a substrate. This is because expansion of parts of the lithographic apparatus can affect the path of the radiation beam, or the positioning of the substrate which the radiation beam is projected onto.

It is desirable to provide, for example, a lithographic apparatus and method which obviates or mitigates one or more of the problems of the prior art, whether identified herein or elsewhere.

### SUMMARY

According to an aspect of the present invention, there is provided a lithographic apparatus that includes an illumination system constructed and arranged to condition a beam of radiation, and a support structure constructed and arranged to support a patterning device. The patterning device serves to impart the beam of radiation with a pattern in its cross-section. The apparatus also includes a substrate table constructed and arranged to hold a substrate, a projection system constructed and arranged to project the patterned beam of radiation onto a target portion of the substrate, and a shutter system constructed and arranged to mask out parts of the patterning device or the substrate from the beam of radiation. The shutter system comprising at least one moveable shutter. The apparatus further includes a control unit arranged to receive information regarding the extent to which the patterned beam of radiation would extend across a periphery of the substrate when being projected onto the target region of the substrate. The control unit is configured to move the shutter by a predetermined amount to affect the parts of the patterning device or the substrate masked out from the beam of radiation if projecting the patterned beam of radiation onto the target portion would involve the patterned beam of radiation extending across the periphery of the substrate.

According to a second aspect of the present invention, there is provided a lithographic method that includes patterning a beam of radiation with a patterning device to impart the beam of radiation with a pattern in its cross-section, and projecting the patterned beam of radiation onto a target portion of a substrate. The method also includes masking out parts of the patterning device or the substrate from the beam of radiation using a shutter of a shutter system and, if projecting the patterned beam of radiation onto the target portion of the substrate would involve the patterned beam of radiation extending across the periphery of the substrate by a predetermined amount, moving the shutter to affect the parts of the patterning device or the substrate masked out from the beam of radiation.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2a and 2b depict known arrangements of a lithographic apparatus, and use of those arrangements,

FIGS. 3a-3c depict an arrangement and operating principles according to an embodiment of the present invention;

FIGS. 4a and 4b depict known arrangements of a lithographic apparatus, and uses of those arrangements; and

FIGS. 5a-5f depict an arrangement and operating principles of another embodiment of the present invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 436, 405, 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

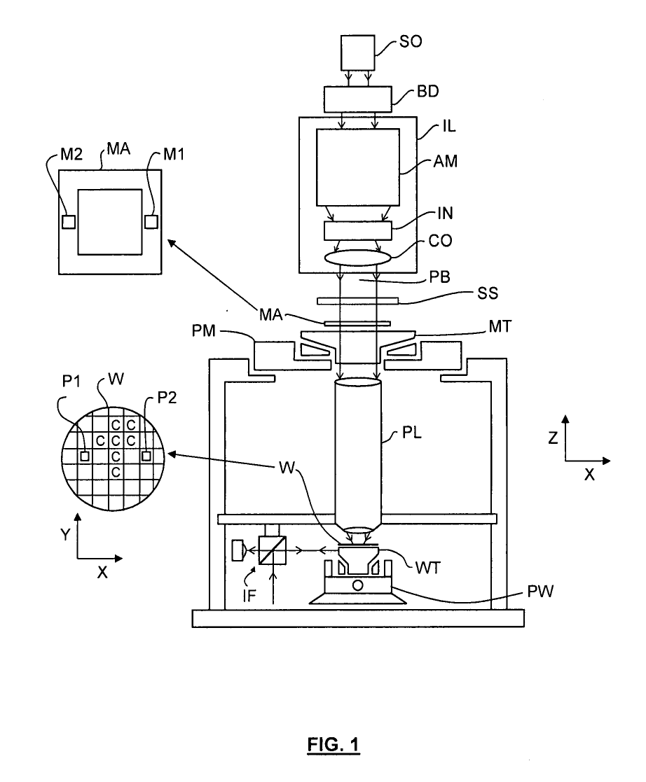

FIG. 1 schematically depicts a lithographic apparatus according to a particular embodiment of the invention. The apparatus comprises: an illumination system (illuminator) IL to condition a beam PB of radiation (e.g. UV radiation or EUV radiation); a support structure (e.g. a support structure) MT to support a patterning device (e.g. a mask) MA and connected to first positioning device PM to accurately position the patterning device with respect to item PL; a shutter system SS for selectively masking out parts of the patterning device MA from the radiation beam PB; a substrate table (e.g. a wafer table) WT for holding a substrate (e.g. a resist-coated wafer) W and connected to second positioning device PW for accurately positioning the substrate with respect to item PL; and a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-) magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

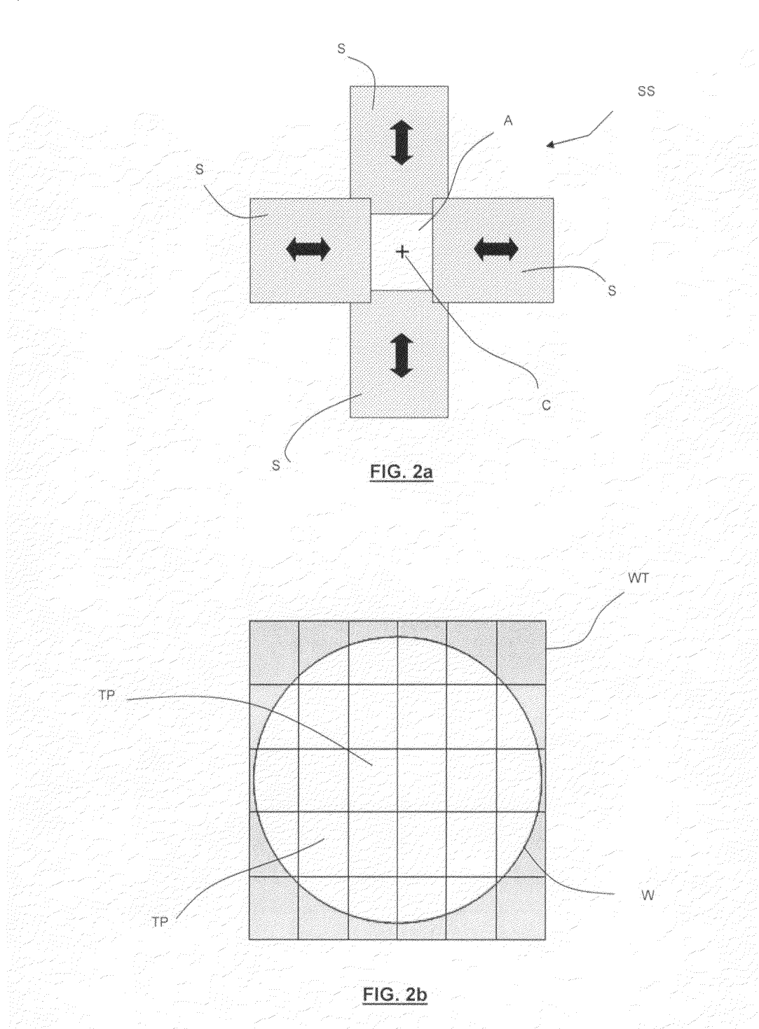

FIG. 2a depicts an embodiment of a shutter system SS that may be used with the lithographic apparatus shown in FIG. 1. The shutter system SS comprises four shutters S (sometimes referred to as blades). The shutters S are disposed about a common center point C, and each shutter S is movable towards and away from the center point C. The shutters S are made from a material which is opaque to the radiation beam PB of FIG. 1.

The shutters S are generally in the same plane. However, this is not essential. For example, one or more of the shutters S may be located at any appropriate position in the lithographic apparatus. For example, one or more of the shutters S may be located after the patterning device MA, or located in the illuminator IL of FIG. 1.

Referring back to FIG. 2a, in use, the shutters S are moved to an appropriate position to mask out specific areas of the patterning device MA (of FIG. 1) from the radiation beam PB. This masking is undertaken to ensure that the radiation beam PB is of a specific cross-sectional area or shape when it is projected onto the substrate W of FIG. 1.

When used in step mode, the shutters S are moved to a desired position to define a certain size aperture A through which the radiation beam PB may pass. The same sized aperture A is used to irradiate all of the target portions of the substrate W. After irradiation of a given target portion, the substrate W is moved so that a different target portion may be irradiated. Before the substrate is moved, another shutter (not shown) is closed to prevent the substrate W from being irradiated while it is moved.

FIG. 2b shows the substrate W held in position by the substrate table WT. Irradiation of target portions TP of the substrate W has already been undertaken. It can be seen that in target portions TP in or around the center of the substrate W, the radiation beam PB which has passed through the aperture A of FIG. 2a has been projected onto (and irradiated) the substrate W only. However, for target portions TP around the periphery of the substrate W, the radiation beam PB has also been projected onto (and has therefore irradiated) the substrate table WT. This is undesirable.

If the radiation beam PB is incident on the substrate table WT, he substrate table will heat it up and expand. Expansion of the substrate table WT may affect the position or positioning of the substrate W. This may make it difficult to accurately apply a pattern to target regions of a substrate W. Additionally, it can be seen from FIG. 2b that when applying patterns to target portions TP around the periphery of the substrate W, only a portion of the available radiation beam PB is actually incident on the substrate W. This means that a large amount of the radiation beam PB is being wasted. In other words, a large portion of the radiation beam PB passing through the patterning device MA and projection system PL shown in FIG. 1 is not incident on the substrate W. Instead, the parts of the radiation beam PB not incident on the substrate W are not only heating up the substrate table WT, but are heating up the projection system PL and patterning device MA as well. The projection system PL is often a large lens. If this lens heats up, it can expand and affect the properties of the radiation beam RB which passes through it. Therefore, expansion of elements of the projection system PL or patterning device MA can also make it difficult to accurately apply patterns to the target portions TP of the substrate W.

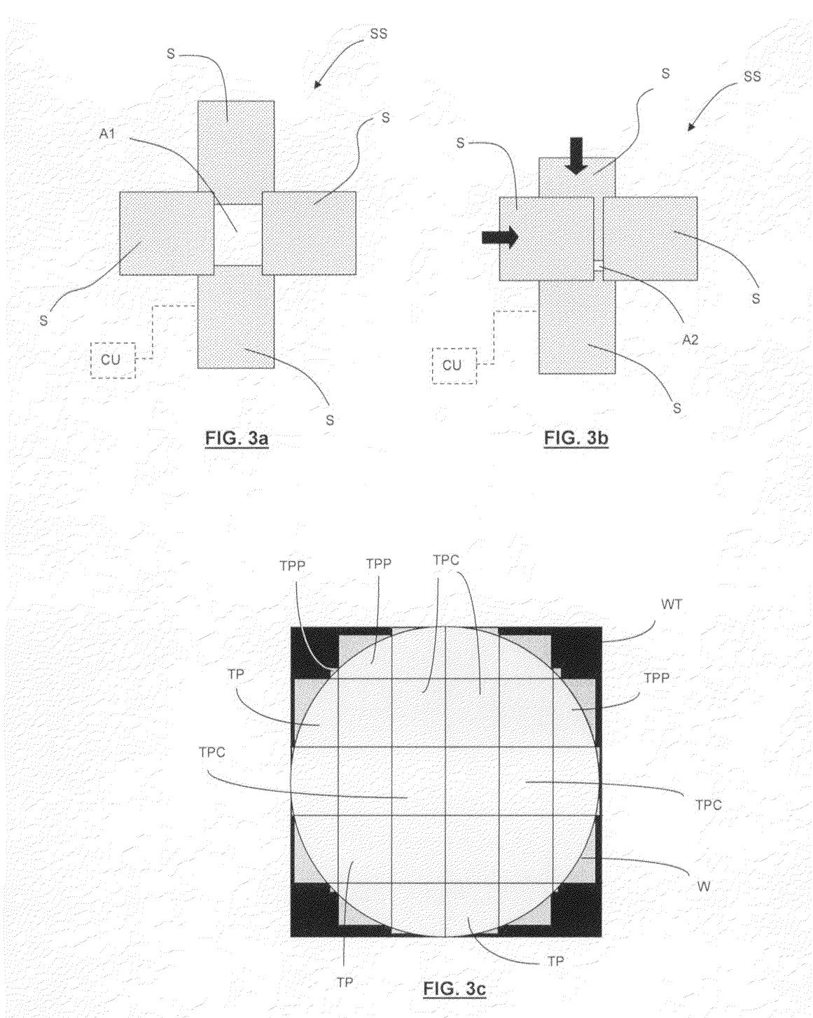

FIGS. 3a-3c illustrate an arrangement and method in accordance with an embodiment of the present invention.

FIG. 3a illustrates an embodiment of the shutter system SS of FIG. 1. The positioning of the shutters S of the shutter system SS is controlled by a control unit CU which is in communication with the shutter system SS. For static exposures (i.e. when the lithographic apparatus operates in step mode), the control unit CU is configured to change the shape of the aperture A1 through which the radiation beam PB passes before the radiation beam is projected onto a target portion of the substrate. Whether or not the shutter S are moved between successive exposures, and to what extent the shutters S are moved, depends upon the location of the target portion TP on the substrate W that is to be irradiated, and the degree to which the radiation beam PB would extend across a periphery of the substrate W if projected onto the substrate W.

For target portions on the periphery of the substrate W, the radiation beam PB will extend across and beyond the periphery of the substrate W, leading to possible irradiation of the substrate table WT. If is known (or can be determined) that the radiation beam PB will, when projected onto the substrate W, extend across and beyond its periphery, the shutters may be moved. Whether or not the shutters S are moved may depend on just how far across the periphery of the substrate W the radiation beam PB will extend. For example, if it is determined or known that the radiation beam PB will, if projected, extend over the periphery by a predetermined amount, the shutters S will be moved.

The predetermined amount maybe greater than 0% and less then 100% of the cross sectional area of the patterned radiation beam that would otherwise have been projected onto the substrate. The predetermined amount may be greater than about 5%, about 10%, about 25%, or about 50% of the cross sectional area of the patterned radiation beam that would otherwise have been projected onto the substrate. The exact value and nature of the predetermined amount may vary for different applications, and for different parts of the substrate. For example, if the target portion of the substrate is square or rectangular, and three of the four corners of the target portion lie on the substrate's surface, it may not be efficient or practical to divide the target portion into smaller target portions which require multiple exposures. In this case, the fact that three corners of the target portion are on the substrate may mean that the radiation beam does not extend across the periphery of the substrate by the predetermined amount, and that therefore the shutters may not be moved. Conversely, if two or less corners of the target portion lie on the substrate, the radiation beam may be taken to extend across the periphery of the substrate by the predetermined amount, and the shutters will be moved (i.e. the predetermined amount is when less than three corners of the target portion lie on the substrate's surface). In another situation, changing the configuration of the shutters S may take longer than it would to move the substrate W for exposure of a different target region. Therefore, in the interests of throughput, it might not be beneficial to change the configuration of the shutters, especially if any expansion caused by radiation not falling on the substrate is negligible. Whether or not the shutters S are moved may therefore be a trade-off between heating and therefore expansion of parts of the lithographic apparatus and throughput.

The control unit CU may detect the position of the substrate W, or be provided with (or refer to) information regarding the position of the substrate W and the target portions TP thereon (e.g. the number of corners of a square or rectangular target portion lying inside or outside the periphery of the substrate W), and/or the movements of the shutters S. Alternatively, the movements of the shutters maybe determined beforehand, either from modelling or from calibrations and/or tests, and stored in a data file. The control unit CU can then access this data file when controlling the shutter S during a set of exposures.

It can be seen in FIG. 3a that, for a static exposure, the shutters S are set in position to define a first aperture size A1. This arrangement of the shutters S maybe used to irradiate target portions TP near the portion center TPC of the substrate W. When it becomes necessary to irradiate target portions TP around the periphery TPP of the substrate W the control unit CU is either provided with information, or determines or refers to information regarding whether the radiation beam PB would extend across the periphery of the substrate W by a predetermined amount. If the predetermined amount is sufficient to warrant movement of the shutters S, the control unit CU moves one or more of the shutters S to create a different and smaller size aperture A2 through which the radiation beam PB may pass, as shown in FIG. 3b. The size and location of the aperture A2 is chosen to minimize the amount of the radiation beam PB which passes through the aperture A2 and irradiates part of the lithographic apparatus other than the substrate W (for example, the substrate table WT).

FIG. 3c depicts a schematic representation of the substrate W when its target portions TP have been irradiated using the method as described in relation to FIGS. 3a and 3b. It can be seen that for the target portions TP around the periphery TPP of the substrate W the exposure area is generally less than for the target portions TP near the center TPC of the substrate W. This may ensure that the portion of the radiation beam PB wasted is considerably reduced.

It will be appreciated that the movement of the shutters S by the control unit CU between successive exposures may be optimized for any particular application. For example, it may be more advantageous to have slightly larger exposure areas around the periphery of the substrate W, and therefore undertake a few exposures. However, it may be more advantageous to further reduce the wastage around the periphery of the substrate W by using small exposure areas (e.g. by defining small aperture sizes in the shutter system SS), and using more exposures.

As mentioned above, by using the control unit CU and method according to the present invention, significant savings can be achieved in the amount of the radiation beam PB which is wasted (and, conversely, the amount of heat that is generated). Referring back to FIG. 2b, if each of the target portions TP is 52 mm wide by 66 mm high, the total area that is exposed to the radiation beam PB in irradiating the entire surface of the substrate W is 102960 mm². In contrast, referring to FIG. 3c the total area exposed to the radiation beam PB is 78027 mm². Given that the surface area of the substrate (in both FIG. 2b and 3c) is 70650 mm², this means that in FIG. 2b an area of 32310 mm² is unnecessarily exposed to the radiation beam PB. This is compared with the unnecessary area (or wasted area) exposed in FIG. 3c, which is 7377 mm². Thus, the portion of the radiation beam PB which is wasted is 77% less using the embodiment described in relation to FIGS. 3a-3c. Similarly, due to restricting the total amount of radiation that is able to pass through the shutter system SS when operated in accordance with an embodiment of the present invention, the patterning device MA and the projection system PL are also exposed to less unnecessary radiation (about 25% less). Thus, it can be seen that the wastage of the radiation beam RB is considerably reduce, and so therefore is the unnecessary heating of parts of the lithographic apparatus.

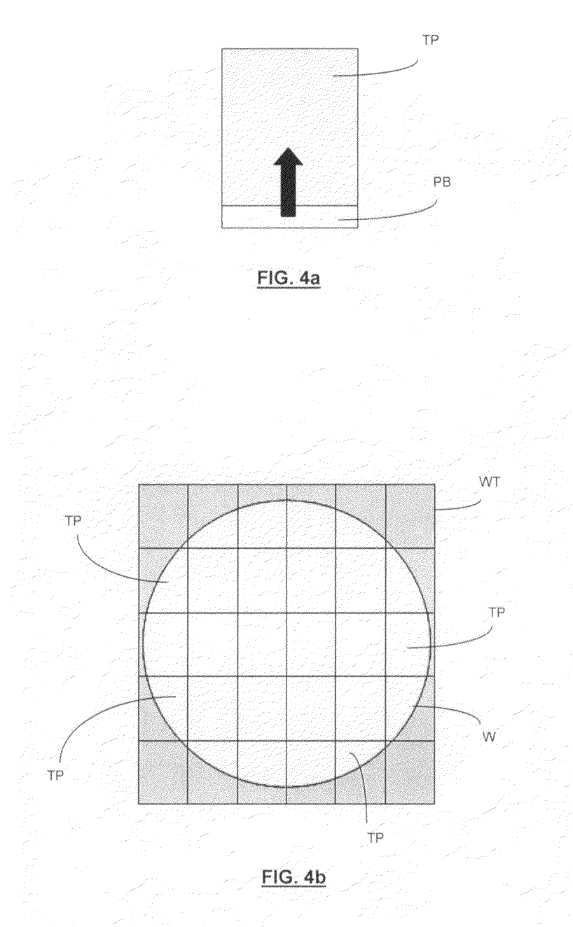

FIGS. 2a-3c describe the use of the lithographic apparatus in step mode, where static exposures are undertaken. The invention is equally applicable to scanned exposures, where the substrate W is moved relative to the radiation beam PB. FIG. 4a shows how the radiation beam PB may be scanned across a target portion TP of the substrate. As described above, in order to scan the radiation beam PB across the target portion TP of the substrate, the support structure MT (of FIG. 1) and the substrate WT are scanned synchronously while the radiation beam PB is projected onto the target portion TP.

FIG. 4b schematically depicts the situation when the radiation beam PB has been scanned across each of the target portions TP of the substrate W in succession. It can be seen that when target portions TP around the periphery of the substrate W are irradiated, a large amount of the radiation beam PB is not incident on the substrate W. Instead, large portions of the radiation beam PB are incident on a substrate table WT supporting the substrate W. This is undesirable, for the reasons given above in relation to FIG. 2b. In essence, it is desirable to reduce the amount of unnecessary irradiation in order to minimize the expansion of various elements of the lithographic apparatus.

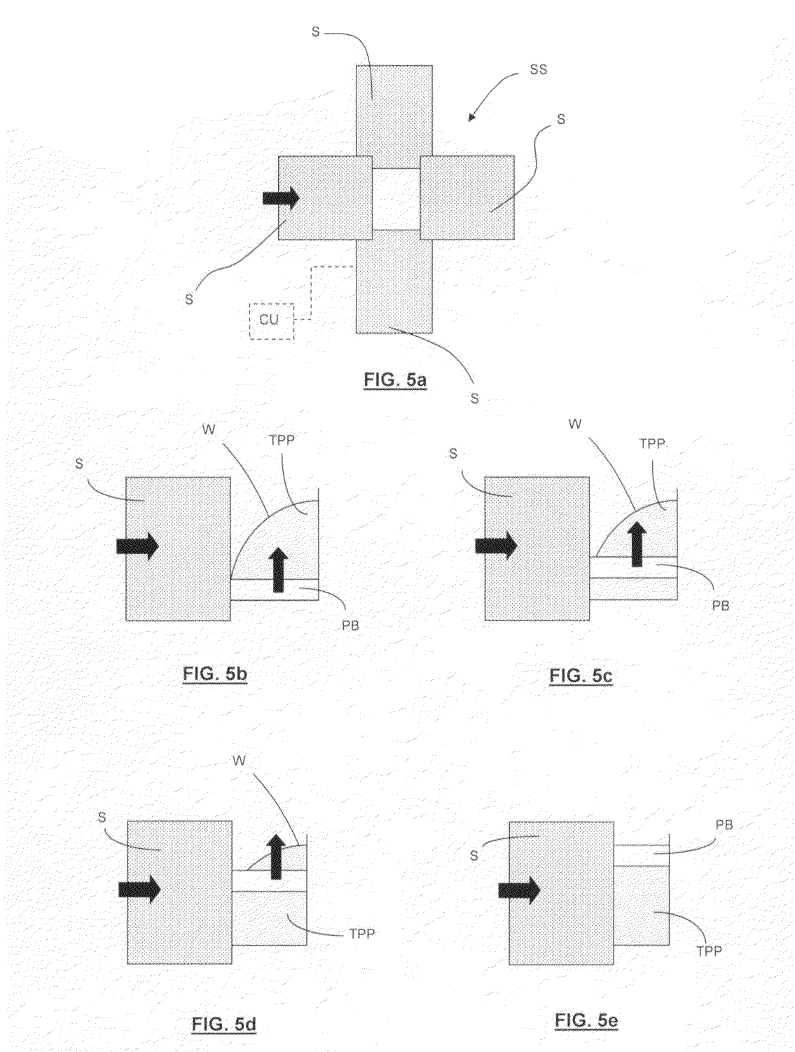

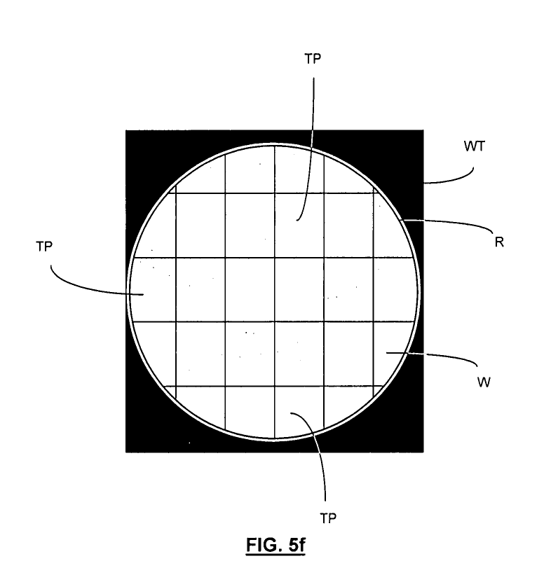

FIGS. 5a-5f illustrate an arrangement and method in accordance with an embodiment of the present invention. FIG. 5a shows the shutter system SS connected to a control unit CU. The control unit CU is configured to adjust the position of one or more of the shutters S on the shutter system SS to minimize the area or areas that are unnecessarily exposed to the irradiation beam PB (as described above in relation to FIG. 3a to 3c). As mentioned above, the control unit CU may detect the position of the substrate W or target portions TP of the substrate W. Alternatively, the control unit CU may be provided with this information, or refer to this information.(e.g. in the form of a data file) either as the exposures are taking place, or beforehand.

FIG. 5b illustrates a peripheral target portion TPP of the substrate W. As described in relation to FIG. 4a, the radiation beam PB is shown as being scanned across the peripheral target portion TPP. It can be seen from FIGS. 5b-5e that as the irradiation beam PB is scanned from the bottom to the top of the peripheral target portion TPP, the control unit CU (of FIG. 5a) effects movement of one of the shutters SS towards the right-hand side of the target portion TPP (as shown in the Figures). The rate at which the shutter S moves is carefully controlled such that the right-most edge of the shutter S (or the masking effect or shadow that it creates) does not fall behind or exceed the lowermost edge of the radiation beam PB as it is scanned across the target portion TP. This means that as the radiation beam PB is scanned across the target portion TPP, the shutter S is moved to minimize the non-substrate areas irradiated by radiation beam PB. That is, only small parts of the radiation beam PB are incident upon surfaces other than the substrate W.

FIG. 5f shows the situation when all the target portions TP of the substrate W have been exposed to the radiation beam PB according to the methods described in relation to FIGS. 5a-5e. It can be seen that the entire substrate W has been exposed to the radiation beam PB, and only a small ring R of the substrate table WT has been exposed to the radiation beam PB. This means that the expansion of the substrate table WT may be minimized. Similarly, since one or more of the shutters S of the shutter system SS are moved to minimize the areas unnecessarily exposed to the radiation beam PB, the patterning device MA and projection system PL are also exposed to the minimum amount of possible radiation, and therefore heat. Therefore, the expansion of the patterning device MA and projection system PL is also minimized, making it easier to accurately apply a pattern to target regions of the substrate.

The shutter S shown in FIGS. 5b to 5e does not need to be moved continuously. Instead, the shutter S can be moved in a number of discrete steps, although it will be appreciated that this may lead to parts of the radiation beam PB not being projected onto the substrate, and consequently being wasted (e.g. irradiating the substrate table WT).

In summary, the present invention may be used to minimize the areas of parts of a lithographic apparatus unnecessarily exposed to the radiation beam PB. The benefits of doing this have been described above in relation to the patterning device MA, projection system PL and the substrate table WT. It will, however, be appreciated that, depending upon the location of the shutters S of the shutter system SS, the amount of unnecessary radiation passing through or onto other parts of the lithographic apparatus may also be reduced. This reduction may lead to a reduction in the expansion of these other parts, which may make it easier to accurately apply a pattern to a target portion of a substrate.

Use of the present invention may also reduce costs. For example, it is often desirable to ensure that various parts of a lithographic apparatus have a very low thermal expansion coefficient. These parts can be very expensive, or difficult to engineer or manufacture. If the amount of heat passing onto or through such parts can be reduced, the parts may not need to exhibit the very low thermal expansion coefficients otherwise required. This is because present invention provides a way of reducing the heating of these parts. Additionally, the lifetime of parts of the lithographic apparatus may be increased by reducing the ‘wear’ on them caused by their exposure to the radiation beam (and consequential heating).

In previous lithographic apparatuses which utilize blade or shutter systems to mask out parts of the patterning device and/or substrate from the radiation beam, corrections are sometimes made for the radiation beam reflecting off the blades/shutters. For example, the intensity or exposure time may be varied to ensure that each target portion on the substrate is exposed to the same dose. It will be appreciated that such corrections may need to be made when using the method and apparatus according to embodiments of the present invention. The corrections may be different for different parts of the substrate, due to the fact that the position of the blades/shutters may be different for different parts of the substrate.

The control unit described above may be a processor or any other appropriate hardware or software. The control unit may be part of a computer program already used to control the movement of the shutters in prior art apparatuses and arrangements.

Although embodiments of the present invention have been described with reference to transmissive patterning devices, it will be appreciated that other types of patterning device (e.g. reflective patterning devices) may equally be used.

While specific embodiments of the invention have been described above, it will be appreciated that the invention may be practiced otherwise than as described. The description is not intended to limit the invention, the invention being defined by the claims that follow.

What is claimed is:

1. A lithographic apparatus comprising:
an illumination system constructed and arranged to condition a beam of radiation;
a support structure constructed and arranged to support a patterning device, the patterning device serving to impart the beam of radiation with a pattern in its cross-section;
a substrate table constructed and arranged to hold a substrate;
a projection system constructed and arranged to project the patterned beam of radiation onto a target portion of the substrate;
a shutter system constructed and arranged to mask out parts of the patterning device or the substrate from the beam of radiation, the shutter system comprising at least one moveable shutter; and
a control unit arranged to receive information regarding the extent to which the patterned beam of radiation would extend across a periphery of the substrate when being projected onto the target region of the substrate, the control unit being configured to move the shutter to affect the parts of the patterning device or the substrate masked out from the beam of radiation if projecting the patterned beam of radiation onto the target portion would involve the patterned beam of radiation extending across the periphery of the substrate by a predetermined amount.

2. A lithographic apparatus as claimed in claim 1, wherein the control unit is configured to move the shutter before the patterned beam of radiation is projected onto the target portion of the substrate.

3. A lithographic apparatus as claimed in claim 1, wherein the control unit is configured to move the shutter while the patterned beam of radiation is being projected onto the target portion of the substrate.

4. A lithographic apparatus as claimed in claim 1, wherein the control unit is a processor.

5. A lithographic apparatus as claimed in claim 1, wherein the shutter system is provided with a plurality of shutters.

6. A lithographic apparatus as claimed in claim 5, wherein the shutter system is provided with four shutters.

7. A lithographic apparatus as claimed in claim 5, wherein the shutters are disposed around a common center point, and are shutter is moveable toward and away from the center point.

8. A lithographic apparatus as claimed in claim 1, wherein the predetermined amount is greater than 0% and less then 100% of the cross sectional area of the patterned beam of radiation that is projected onto the substrate.

9. A lithographic apparatus as claimed in claim 8, wherein the predetermined amount is greater than about 25% of the cross sectional area of the patterned beam of radiation that is projected onto the substrate.

10. A lithographic apparatus as claimed in claim 9, wherein the predetermined amount is greater than about 50% of the cross sectional area of the patterned beam of radiation that is projected onto the substrate.

11. A lithographic apparatus as claimed in claim 1, wherein the target portion is square or rectangular.

12. A lithographic apparatus as claimed in claim 11, wherein the predetermined amount is when more than one corner of the square or rectangular target portion lies outside the periphery of the substrate.

13. A lithographic apparatus as claimed in claim 1, wherein the predetermined amount is different for different target portions of the substrate.

14. A lithographic method comprising:
patterning a beam of radiation with a patterning device to impart the beam of radiation with a pattern in its cross-section;
projecting the patterned beam of radiation onto a target portion of a substrate; and
masking out parts of the patterning device or the substrate from the beam of radiation using a shutter of a shutter system and, if projecting the patterned beam of radiation onto the target portion of the substrate would involve the patterned beam of radiation extending across the periphery of the substrate by a predetermined amount, moving the shutter to affect the parts of the patterning device or the substrate masked out from the beam of radiation.

15. A lithographic method as claimed in claim 14, wherein the shutter is moved before the patterned beam of radiation is projected onto the substrate.

16. A lithographic method as claimed in claim 14, wherein the shutter is moved while the patterned beam of radiation is projected onto the substrate.

17. A lithographic method as claimed in claim 14, wherein the determination of whether projecting the patterned beam of radiation onto the target portion of the substrate would involve the patterned beam of radiation extending across the periphery of the substrate by the predetermined amount is undertaken before the beam of radiation is projected onto that target portion.

18. A lithographic method as claimed in claim 14, wherein the determination of whether projecting the patterned beam of radiation onto the target portion of the substrate would involve the patterned beam of radiation extending across the periphery of the substrate by the predetermined amount is undertaken for all parts of the substrate before the patterned beam of radiation is projected onto any part of the substrate.

19. A lithographic method as claimed in claim 18, wherein information relating to the parts of the substrate that would involve the patterned beam of radiation extending across the periphery of the substrate by a predetermined amount is stored in a data file.

20. A lithographic method as claimed in claim 14, wherein the determination of the movements of the shutter is undertaken for all parts of the substrate before the patterned beam of radiation is projected onto any part of the substrate.

21. A lithographic method as claimed in claim 20, wherein information relating to the movements of the shutter is stored in a data file.

22. A lithographic method as claimed in claim 20, wherein reference is made to the data file in order to determine what movements of the shutter are required.

23. A lithographic method as claimed in claim 14, wherein the predetermined amount is greater than 0% and less then 100% of the cross sectional area of the patterned beam of radiation that is projected onto the substrate.

24. A lithographic method as claimed in claim 23, wherein the predetermined amount is greater than about 25% of the cross sectional area of the patterned beam of radiation that is projected onto the substrate.

25. A lithographic method as claimed in claim 24, wherein the predetermined amount is greater than about 50% of the cross sectional area of the patterned beam of radiation that is projected onto the substrate.

26. A lithographic method as claimed in claim 14, wherein the target portion is square or rectangular.

27. A lithographic method as claimed in claim 26, wherein the predetermined amount is when more than one corner of the square or rectangular target portion lies outside the periphery of the substrate.

28. A lithographic method as claimed in claim 14, wherein the predetermined amount is different for different target portions of the substrate.

29. A lithographic method as claimed in claim 14, wherein movement of the shutter is controlled by a control unit.

30. A lithographic method as claimed in claim 29, wherein the control unit refers to a data file to determine when and to what extent to move the shutter.
